(19) United States
(12) Patent Application Publication
(10) Pub. No.: US 2018/0131451 A1
(43) Pub. Date: May 10, 2018

(54) A POWERING UNIT OF REVERSE POWER FEED TYPE FOR DIGITAL COMMUNICATION APPLIANCES AND RELATED METHOD FOR GENERATING A SUPPLY VOLTAGE IN REVERSE POWER FEED MODE

(71) Applicant: A TLC S.R.L., Roma (RM) (IT)

(72) Inventor: Stefano MARCHETTI, Osimo (AN) (IT)

(21) Appl. No.: 15/574,879

(22) PCT Filed: May 17, 2016
(86) PCT No.: PCT/IB2016/052865

§ 371 Date: Nov. 17, 2017

(30) Foreign Application Priority Data
May 18, 2015 (IT) 102015000015436

(51) Int. Cl. H04B 10/80; H04B 10/27; H04L 12/10; H04L 12/931; H04L 29/06

(52) U.S. Cl. CPC H04B 10/808; H04B 10/27; H04L 69/24; H04L 49/351; H04L 49/40; H04L 12/10

(57) ABSTRACT

Disclosed is a method, implemented in a related supply unit, for generating a supply voltage for electronic appliances of digital communications that allows to dampen noise in the communication bandwidth by reducing the frequency of switching noise when the number of active phone lines connected to the supply unit increases, senses which phone lines are active and, at each switching cycle, allows that a certain amount of electric energy is absorbed by one active line at the time. The method is implemented in a related supply unit.

### TECHNICAL FIELD

This disclosure relates in general to communication systems and more in particular to an unit of reverse power feed mode of an appliance for digital communications and a related method for generating a supply voltage in a reverse power feed mode for an appliance for digital communications with equal sharing, among the active phone lines, of the electric power required by the appliance.

### BACKGROUND

With an ever increasing demand by users of transmitting and receiving even greater amounts of information, telecommunication firms are pushed to update their infrastructures of communication networks. In order to provide more information at even increasing rates, improvements of the communication network are requested in order to have an ever increasing bandwidth. To this end, fiber-optic telecommunication networks are even more diffused, that support data transmission rates in the order of one Gigabit over relatively large distances.

Even having the possibility of installing an optical fiber in the home of each single user, because of reasons of costs the existing phone line is used (i.e. the copper twisted pair) for transmitting information of digital communications from a distribution point to each single user. FTTdP (Fiber To The distribution Point) architectures have been developed, that are broadband telecommunication architectures in which there is a data transceiving optical fiber that connects an operating center to a distribution point at which there is an electronic appliance for digital communications, to which the phone lines of a plurality of users are coupled.

The copper twisted pair constituting phone lines, does not support large bandwidths for long distances, thus electronic appliances for digital communications are installed at a distribution point as close as possible to users, so as to maximize data transceiving rate of each user. These electronic appliances may be installed in cabins at street level, or on telephone poles or yet in the basement of a building.

Even if power absorbed by these electronic appliances are relatively small, they may be connected to a suitable line at which a supply voltage is made available. Nevertheless, an electric supply could not be available in the neighborhood of a distribution point at which the electronic appliance is installed.

In order to obviate to this inconvenient, a first solution, schematically depicted in FIG. 1 with reference to an example in which a distribution point manages data connections xDSL for eight houses C-1 . . . C-8, contemplates an electronic appliance at the distribution point remotely supplied by an operating center through N dedicated supply lines.

The features of this remote supply architecture are:
relatively great supply voltages in order to keep involved currents within electric safety limits imposed by laws (EN 60950-21 for RFT-C modes in general);
high voltages and low currents allow to transmit energy at long distances with small losses through connection cables;
the pairs used for carrying supply currents have the same length (they are part of a same cable);
the pairs shall not be electrically isolated;
the currents flowing throughout the single pairs sum up at the input of a remote DC/DC converter;
therefore, only one DC/DC converter is used for generating the secondary voltages required to the functioning of the appliance (x-Dsl or G-Fast);
electric stresses (extra-voltages, unbalancing toward ground, disturbances and noise, etc) of one pair of the pairs influence all the pairs that constitute the supply system;
control systems must be contemplated for minimizing risks of electric shocks for operators.

This solution implies relevant drawbacks in terms of energy losses and of installation costs of supply lines.

An alternative solution called Reverse Power Feed (RPF), wherein power required for supplying the electronic appliance in the distribution point is delivered by each user through the telephone line (typically made of a copper twisted pair) that connects an user with the appliance, has been proposed by exploiting the fact that in FTTdP architectures the distribution point is close to the user. According to this solution, the telephone line of each user is used to make available an electric DC supply for the electronic appliance and for exchanging data signals between users and the appliance. As schematically depicted in FIG. 2, with this technique it is not necessary to install N electric supply lines from the operating center to the distribution point. The electronic appliance at the distribution point is configured for exchanging data signals (for example xDSL, as shown in figure) only throughout telephone lines on which a DC supply voltage is made available, without involving telephone lines (in the example shown in the figure, the line of the user C-6) at which this supply voltage is not made available. When an user wants to be connected, his device for digital communications applies a DC voltage at his telephone line in order to enable the electronic appliance at the distribution point.

In order to implement this technique, at the distribution point there is also a supply unit that is connected in input to the telephone lines and that generates a supply voltage for the electronic appliance when a DC supply voltage is made available at least at one of the telephone lines. In order to make users pay also with the Reverse Power Feed (RPF) technique the electric energy absorbed by the electronic appliance proportionately to the use they make of it, the supply unit is configured for absorbing the electric power needed for the functioning by sharing it in equal measure among the active telephone lines at which a supply voltage is made available.

A prior supply line, that performs these functions, is schematically depicted in FIG. 3a. It is substantially composed of a primary block (at the left side in the figure) and of a secondary block (at the right side in the figure).

The primary block is composed of a plurality of primary circuits identical among them, each having:
a pair of input terminals (L1_a, L1_b; L2_a, L2_b; . . . ; LN_a, LN_b) to which the wires of a respective telephone line (Line1; Line2; . . . ; LineN) are connected;
an input circuit, that in the supply unit is composed of a protection circuit against overvoltages PROTECTION, by a low-pass filter INPUT FILTER and by a rectifying diode bridge that makes available a rectified DC voltage on intermediate nodes (1_a, 1_b; 2_a, 2_b; . . . ; N_a, N_b), among which there is a respective hold capacitor (C1; C2; . . . ; CN);
a primary winding (L1p; L2p; . . . ; LNp) connected to an intermediate node (1_a; 2_a; . . . ; N_a) and connected to the other intermediate node of the intermediate nodes (1_b; 2_b; . . . ; N_b) through a switch (SW1; SW2; . . . ; SWN);
a DC-DC voltage converter (Dc/Dc_1; Dc/Dc_2; . . . ; Dc/Dc_N) enabled by a respective command signal (E1; E2; . . . ; EN) and supplied by the rectified voltage available at intermediate nodes (1_a, 1_b; 2_a, 2_b; . . . ; N_a, N_b), configured for switching cyclically on/off the switch (SW1; SW2; . . . ; SWN) when the command signal (E1; E2; . . . ; EN) is active.

The secondary block comprises:
as many secondary windings (L1s; L2s; . . . ; LNs) as the primary windings of the primary block, so as each primary/secondary winding is magnetically coupled only to a respective secondary/primary winding and is magnetically decoupled by the other primary/secondary windings;
a control block connected to all secondary windings and supplied with the voltages induced thereat, configured for generating command signals (E1; E2; . . . ; EN) when it senses a non null voltage induced at the respective secondary windings, and configured for generating an unregulated voltage obtained by combining the induced voltages at the secondary windings;
a secondary circuit with rectification (eventually synchronous as in the figure) and a low-pass filter (Output Filter), configured for generating at the output terminals +VOUT, −VOUT of the supply unit a supply voltage obtained as a low-pass filtered replica of the voltage delivered by the control block.

The control block, commonly called secondary sharing system or system with a current “o-ring”, senses voltages and currents delivered by each secondary winding corresponding to an active telephone line, and controls each DC-DC converter in a feedback mode in order to keep equal voltages and currents delivered each instant by these secondary windings.

In general, peculiar features of this supply technique are the following:
typically, applied supply voltage are in the so-called SELV ranges by the laws (V<=60 Vdc), in order to meet electric safety conditions imposed by laws (EN 60950-1) actually in force for ITU (Information Technology Unit) appliances;
voltages in the SELV ranges and higher currents, allow to transmit energy up to the distances established by the type of broadband service (200/250 m maximum);
power losses along longer cables may be neglected;
user's pairs used for remotely transmitting supply currents have not the same length;
user's pairs must be electrically insulated;
powers delivered by each single user must be equal to each other and equal to the overall power divided by the number of users connected to the service (line losses are neglected, because of the above reasons);
each user may connect himself to the data service in a completely independent fashion at each time without causing malfunctioning to the remote supply system nor to other users;
a “sharing” of the available power is implemented, in order to ensure the correct generation of the secondary voltage needed to the functioning of the x-Dsl or G-Fast appliance;
electrical stresses (overvoltages, unbalancing toward ground, disturbances and noise, etc.) of one of the pairs shall not influence the other pairs of the remote supply system. FIG. 3b is a picture of the supply unit (at the low side) of FIG. 3a, connected to an electronic appliance (at the high side) for FTTdP digital communications. The picture shows 8 primary circuits and as many secondary circuits, one insulated from the other, that occupy a great space that does not allow to reduce further the size of the board. Moreover the architecture of the supply unit of FIG. 3a is relatively complex and expensive and, usually, is affected by switching noise that is re-injected in the communication band if appropriate filtering circuit are not used, and that reduces the signal-to-noise ratio penalizing the transceiving data rate.

### SUMMARY

Studies carried out by the applicant in order to reduce noise in the bandwidth generated by the known supply unit, lead to infer that this noise is at least in part due to commutation of switches of the primary circuits, that are cyclically turned on/off at a fixed frequency.

A method, implemented in a related supply unit, for generating a supply voltage for electronic appliances of digital communications, has been found, that allows to dampen noise in the communication bandwidth by reducing the frequency of switching noise when the number of active phone lines connected to the supply unit increases.

This excellent result has been obtained with a supply unit and a method for generating a supply voltage as defined in the annexed claims.

According to an embodiment, the supply unit may have a simpler architecture than the architecture of known supply units and thus it may be realized with boards having reduced size.

With the supply unit of this disclosure, it is possible to share the electric power absorbed by the electronic appliance only among the active telephone lines, choosing whether to make equal for all connected users either the electric power injected into the active telephone lines upstream the supply unit or the electric power that the supply unit absorbs by the active telephone lines.

The claims as filed are integral part of this specification and are herein incorporated by reference.

### BRIEF DESCRIPTION OF THE DRAWINGS

FIG. 1 depicts a supply scheme of an appliance for digital communications installed at a distribution point connected to eight telephone lines, through as many supply lines installed parallel to the optical fiber between an operating center and the distribution point.

FIG. 2 shows a supply scheme in a Reverse Power Feed mode of an appliance for digital communications installed at a distribution point connected to eight telephone lines one of which is inactive.

FIG. 3a is a circuit scheme of a known supply unit in a Reverse Power Feed mode, of an appliance for digital communications.

FIG. 3b is a picture of the supply line of FIG. 3a functionally connected to an electronic appliance for xDSL communications.

FIG. 4 depicts a particular embodiment of a supply line of this disclosure, adapted for supplying electronic appliances of digital communications in a Reverse Power Feed mode.

FIG. 5 is an equivalent electrical scheme of a supply system in a Reverse Power Feed mode of an electronic appliance for digital communications.

FIG. 6 is a graph obtained through simulations that illustrates variation of the power absorbed by primary circuits of FIG. 5 when the voltage available at the respective input terminals varies.

FIG. 7 shows three switching pulses of switches of the primary circuits of FIG. 5 having a bandwidth as large as smaller is the input voltage of the respective primary circuit.

FIG. 8 is a time graph that illustrates the functioning of the supply unit that implements the method of this disclosure when a third telephone line is active and contributes with the other two active lines to supply an appliance for digital communications.

FIG. 9 is a time graph that illustrates the functioning of the supply unit when controlled for absorbing a same peak current from each active phone line.

FIG. 10 is a scheme of a control block of the supply unit of this disclosure according to an embodiment.

FIG. 11 is a flow chart of the operations carried out by the control block of FIG. 10.

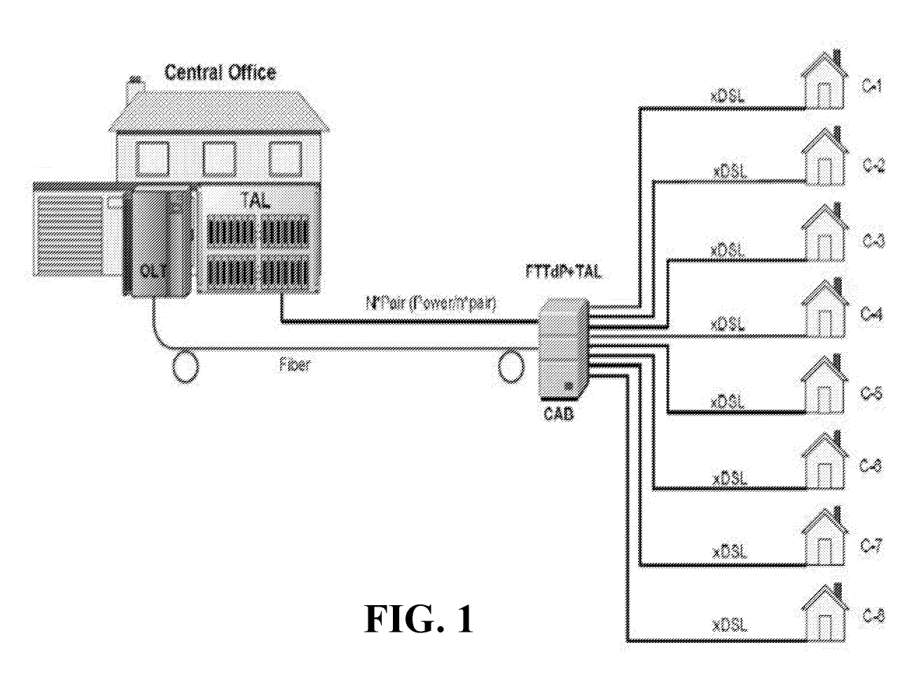

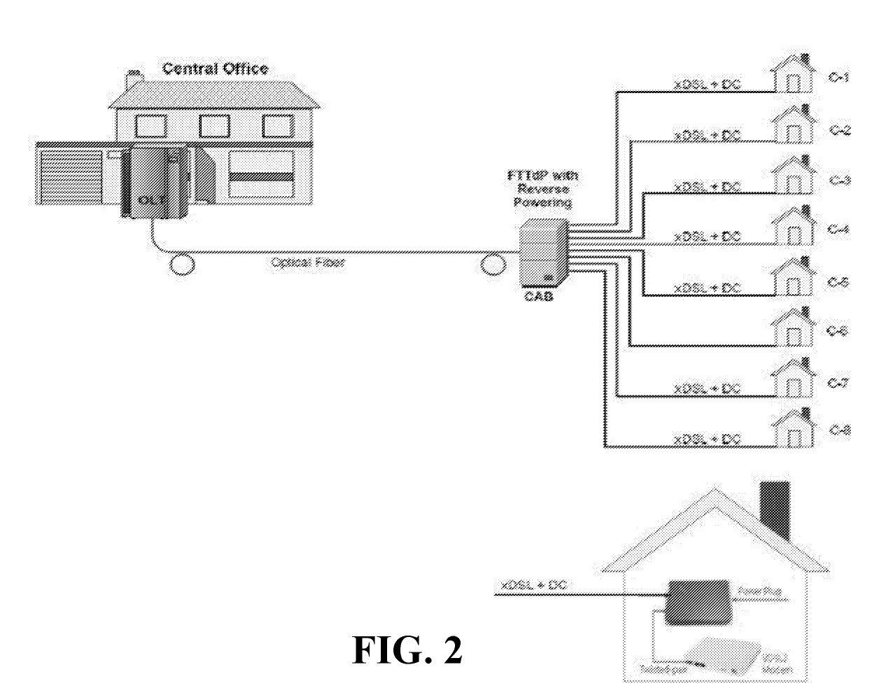

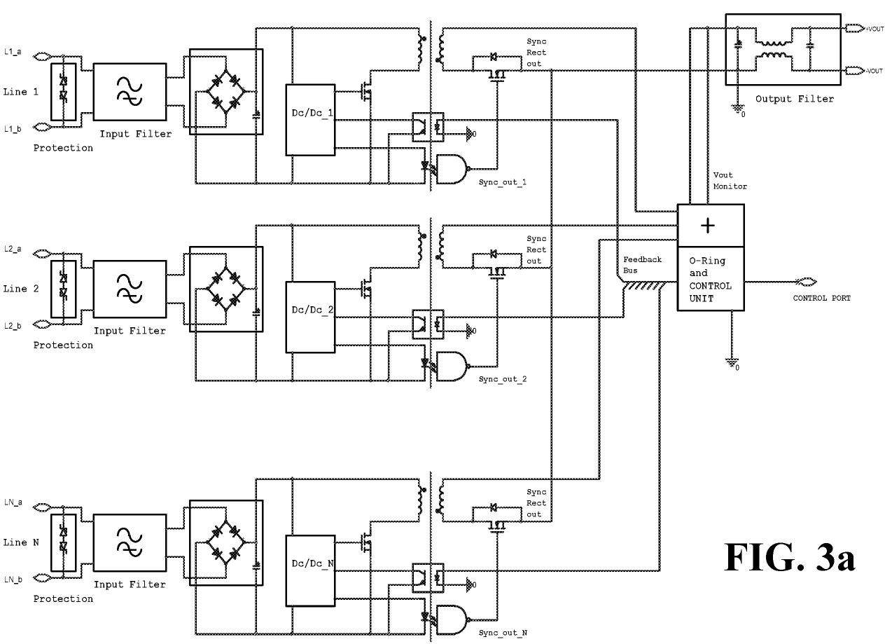

### DETAILED DESCRIPTION

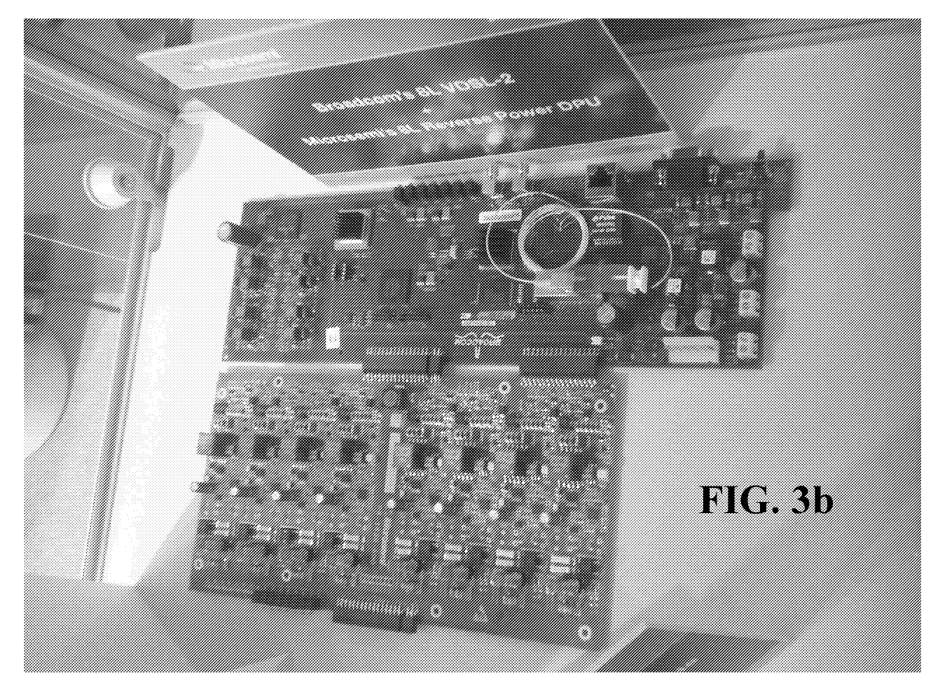

A detailed scheme of a preferred embodiment of a supply unit according to this disclosure is shown in FIG. 4. This supply unit has a number N of identical primary circuits each connected to a respective phone line and each having a respective primary winding connected to a series switch. According to the method of this disclosure, the switches of the primary circuits connected to the telephone lines at which a DC supply voltage is made available (hereinafter called “active” lines) are controlled so as to be turned on/off during different switching cycles. In practice, at each switching cycles only one of the switches of the control circuits supplied with a non null DC primary voltage is switched.

As a consequence, only one primary winding is crossed by current in each switching cycle, thus conveniently all primary windings may be magnetically coupled to a same secondary winding functionally connected to the output terminals of the unit for making available the DC supply voltage for an electronic appliance for digital communications. Conveniently, the primary windings and the sole secondary winding are magnetically coupled among them over a same magnetic core, in order to reduce further the size. According to a less preferred embodiment, because it is more cumbersome, the supply unit has a plurality of secondary windings, eventually also a secondary winding magnetically coupled only to the respective primary winding, and all the secondary windings are functionally connected to the output terminals of the unit for making available the DC supply voltage.

According to an embodiment of the method of this disclosure, the electric power absorbed by each active telephone line is controlled by sensing the current flowing throughout the respective primary winding.

When a DC voltage is sensed aver a phone line, then that phone line is “active” i.e. the user connected thereto wants to transmit/receive data. At each switching cycle, the respective primary winding is kept in a conduction state for a certain on time Ton while measuring, at each cycle, the value of the current that flows throughout the primary winding, in order to control the power delivered by each primary circuit.

The current flowing throughout a primary winding in an on interval Ton varies linearly depending upon the applied voltage Vdc and upon the value of the inductance Lp of the winding itself. The peak value Ip of this current is:

$$Ip = \frac{Vdc \cdot Ton}{Lp}$$

This value determines the stored magnetic energy Em, that is equal to:

Em=½·Lp·Ip²

In the hypothesis of yield equal to one, the electric power Pout that may be transferred to the secondary equals the electric power Pin absorbed by the primary winding and it is given by:

$$Pout = Pin = \frac{1}{2} \cdot \frac{Lp \cdot {Ip}^{2}}{T}$$

being T the period of a switching cycle, given by

$$T = \frac{1}{Fsw}$$

wherein Fsw is the switching frequency.

By substituting the value of the peak current Ip in the previous equation:

$$Pin = \frac{1}{2 \cdot T \cdot Lp} \cdot {( Vdc \cdot Ton )}^{2}$$

Keeping into account the yield η different from one:

$$Pout = η \cdot Pin = η \cdot \frac{1}{2 \cdot T \cdot Lp} \cdot {( Vdc \cdot Ton )}^{2}$$

As it is possible to notice, the absorbed power (and thus the power transferred depending upon the yield η), keeping constant the switching period T and the inductance Lp, depends only upon Vdc and Ton.

Therefore, it is inferred that, by controlling the peak value of the current Ip throughout the winding it is possible to determine the delivered power and, by varying the duration of the on time Ton, it is possible to compensate variations of the DC voltage Vdc made available at an active phone line.

Basically, a time multiplexing of the N remote supplies is realized by applying to each one the above illustrated method.

Basically, with such a time multiplexing there is no cross-talking among the windings at the primary side (induced voltages) and it is possible to share correctly the requested power. Moreover, because of the fact that the primary voltages are switched one at the time per each switching cycle, a single secondary winding magnetically coupled with all primary windings is sufficient.

Conveniently, all primary windings and the secondary winding are magnetically installed around a single magnetic core.

Making reference to FIG. 4, let us suppose of having N primary windings having a same inductance Lp [51], [52], . . . [5N]. Each of these windings is connected to a switch [71], [72], . . . [7N], controlled so as to remain on for a time Ton_{N} every N periods of T, working at a frequency of 1/(N*T) that is Fsw/N (being Fsw=1/T). The on time Ton_{N} as a general rule may vary from a primary circuit to another one. Obviously, the on times Ton_{N} of each switch will be timely shifted with a repetition period N*T. In other words, the windings are controlled in a time multiplexing mode in the interval N*T.

Differently, the secondary winding will be crossed by current at each period T, thus it will work at a working frequency equal to Fsw. In practice, the working frequency at the secondary side will be invariant when the N available supplies vary whilst the working frequency of the primary windings will be smaller the greater is the number of active telephone lines.

In the hypothesis of operating a control on the absorbed peak current, cycle after cycle, on the various primary windings in order to deliver a certain power level, for each supply voltage Vdc_{N} there is a switching time Ton_{N} every time different, in order to keep constant the product Vdc_{N}*Ton_{N}.

Therefore, during the time Ton_{N} a current having a maximum value Ip will flow throughout each winding, the current may be made equal for all windings making equal the products Vdc_{N}*Ton_{N}.

Indeed, for each winding and thus for each supply line it is:

$$Ip = \frac{{Vdc}_{N}}{Lp} \cdot {Ton}_{N} being Ip = constant$$

that is by adjusting the on time Ton_{N} it is possible to compensate the different increase of the current throughout the inductance Lp of each winding, determined by the different applied DC voltage Vdc_{N}.

Therefore, by averaging during the overall repetition time the current absorption Ip for each line, it is:

$${Pin}_{N} = \frac{[ ( Ip / 2 ) \cdot {Vdc}_{N} \cdot {Ton}_{N} ]}{N \cdot T} = \frac{Pout}{η} \cdot \frac{1}{N}$$

It is thus demonstrated that the overall delivered power, even considering the conversion yield η (that is identical for all lines), may be split in equal shares among all N active telephone lines connected to the supply line.

This power sharing takes place while keeping the galvanic insulation among the different phone lines and the primary circuits, because the N primary windings are insulated among them.

Another relevant advantage of this scheme is the fact that the switching frequency of each switch is smaller the greater the number N of active phone lines connected to the supply unit. The reduction of the switching frequency increases the overall yield, because the switching losses due to the decrease of the average current absorbed by each active phone line decrease. The amplitudes of the noise frequency components due to switching for each active phone line decrease, and the components occupy a lower frequency band the greater the number of active phone lines, thus filtering the input of each primary circuit will be less onerous. Moreover, this enhances the signal-to-noise ratio of the data transceiving because switching noise is even more outside the data transmission bandwidth when the number of active lines increases.

Only one primary winding at the time is switched at each switching cycle, thus the supply unit may be realized using a single magnetic core, thus reducing the overall size of the unit and making it adapted to be installed also in narrow spaces.

Finally, the overall cost of such a supply unit is smaller than the cost of known supply units realized with N independent converters.

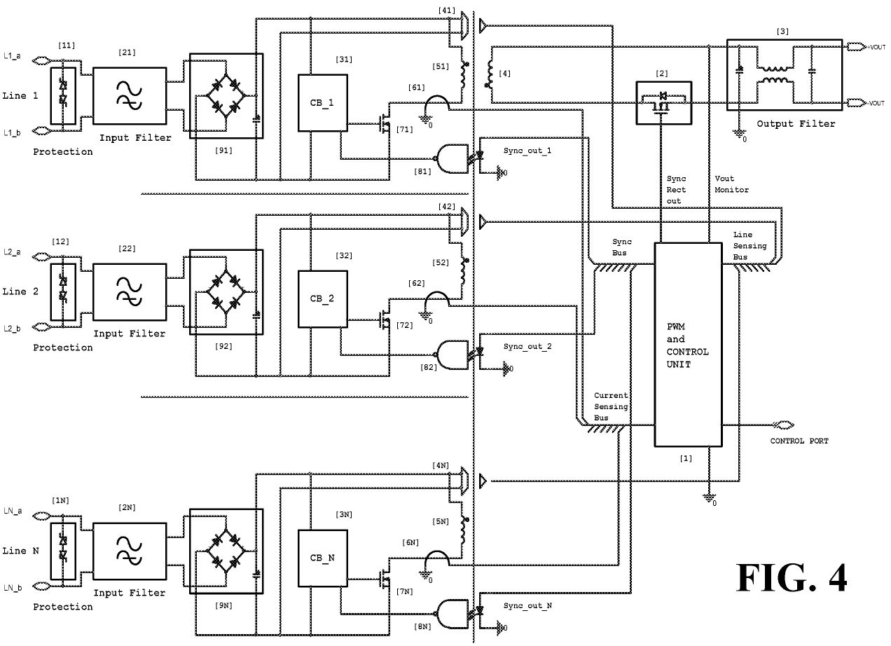

In order to show how the supply unit of this disclosure functions when taking into accounts the losses along the phone lines, reference will be made to the simplified electric scheme of FIG. 5, in which each phone line is represented by two resistances having a same value and in which it is assumed that the DC voltage Vg delivered by each user is the same. The primary circuits are represented by the blocks Prim1, Prim2, . . . , PrimN and the case in which there is only one secondary winding magnetically coupled with all primary winding is considered.

From the depicted scheme, it is possible to notice that each primary circuit is connected, at its input, with a line having a different length, that thus has a certain electric resistance R1, R2, . . . , RN for each branch of the connection.

The system will be analyzed by neglecting the reactive components of the phone lines (i.e. inductances and capacitances per unit length) making reference to a generic N-th primary circuit by calculating the power delivered by a generic N-th voltage generator Vg connected to the corresponding N-th phone line.

As stated before,

$${Pin}_{N} = \frac{1}{2 \cdot T \cdot Lp} \cdot {( VN \cdot {Ton}_{N} )}^{2}$$

thus the overall power Pg_{N} delivered by the N-th voltage generator Vg is given by:

$${Pg}_{N} = {Pin}_{N} + {Pline}_{N} = {Pin}_{N} + \frac{{( Vg - VN )}^{2}}{2 \cdot RN} = \frac{{Vg}^{2}}{2 \cdot RN} - \frac{2 \cdot Vg}{2 \cdot RN} \cdot VN + \frac{{VN}^{2}}{2 \cdot RN} + \frac{{Ton}_{N}^{2} \cdot Fsw}{2 \cdot Lp} \cdot {VN}^{2}$$

wherein Pline_{N} is the electric power dissipated on the N-th phone line. Being:

$${K}_{N} = \frac{Fsw}{2 \cdot Lp} \cdot {( {Ton}_{N} )}^{2}$$

it is:

$$\frac{{Vg}^{2}}{2 \cdot RN} - {Pg}_{N} - \frac{Vg}{RN} \cdot VN + {VN}^{2} \cdot ( \frac{1}{2 \cdot RN} + {K}_{N} ) = 0$$

Being:

$$a = ( {K}_{N} + \frac{1}{2 \cdot RN} ) ;$$

$$b = - \frac{Vg}{RN} ;$$

$$c = \frac{{Vg}^{2}}{2 \cdot RN} - {Pg}_{N} ;$$

it is:

α·VN²+b·VN+c=0

Imposing real and coincident roots for VN:

b²−4˜a·c=0

it is:

$${Ton}_{N} = \sqrt{\frac{2 \cdot {Pg}_{N} \cdot Lp}{( Fsw \cdot ( {Vg}^{2} - 2 \cdot {Pg}_{N} \cdot RN )}} ;$$

$$and$$

$$VN = \frac{Vg}{2 \cdot RN} \cdot \frac{1}{( {K}_{N} + \frac{1}{2 \cdot RN} )} .$$

Let us consider for example a realistic case of 3 phone lines with the following values of RN, Vg, PgN that represent a typical case of an user with remote supply in a “Reverse-Powering” for connecting with G.fast or VDSL transmission technology:

R1=2 Ohm (case of a cable Ø=0.5 mm and length=25 m.)

R2=4.5 Ohm (case of a cable Ø=0.5 mm and length=100 m.)

R3=11 Ohm (case of a cable Ø=0.5 mm and length=250 m.)

Vg=56V and Pg_{N}=10 W

The following results for VN, Ton_{N} and Pin_{N} are respectively obtained:

| Line | Pg_{N} (W) | VN (V) | Ton_{N} (μs) | Pin_{N} (W) |
|---|---|---|---|---|
| 1 | 10 | 55.2857 | 2.8416 | 9.8724 |
| 2 | 10 | 54.3928 | 2.8648 | 9.7130 |
| 3 | 10 | 52.0714 | 2.9280 | 9.2984 |

thus, even if the lengths of the phone lines are much different among them (line 3 is ten times longer than line 1), the electric power absorbed by each primary circuit of the supply unit, that implements the method of this disclosure, differs for less than 7%. These differences are commonly considered negligible in the practice.

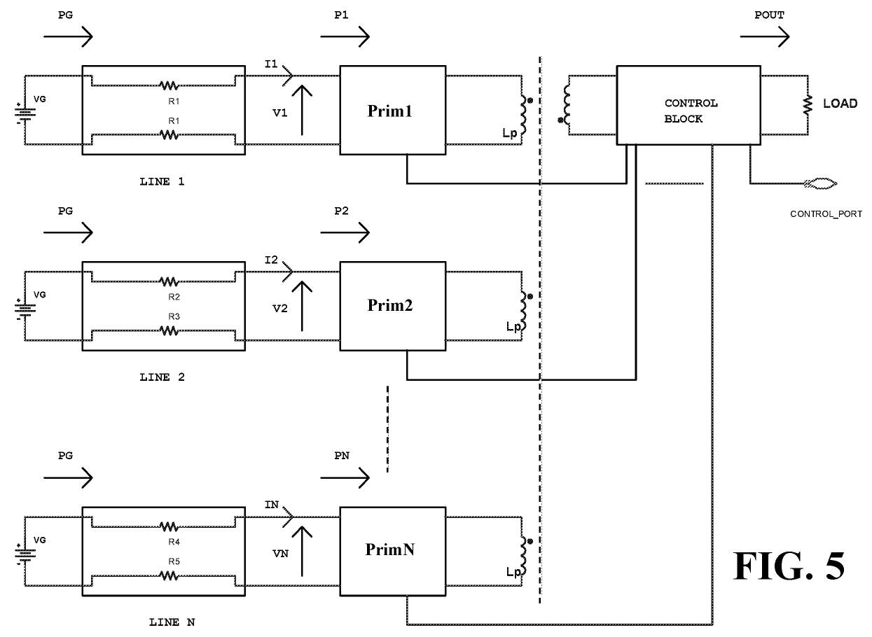

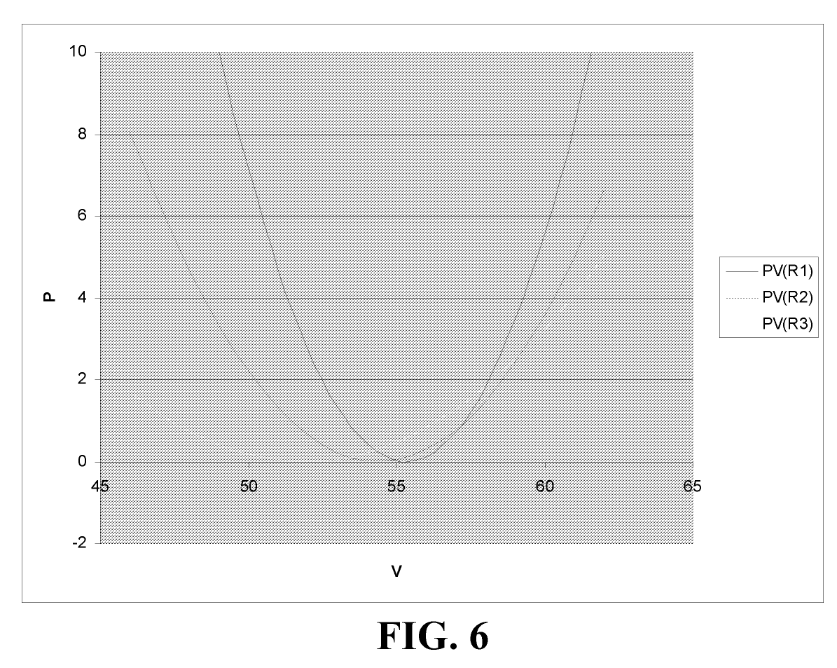

FIG. 6 depicts the graph of PgN in function of VN for the three considered cases: the value of the x-intercept deduced from the intersection of the parabola with the x axis represents the value of VN available at the input of the converter for that fixed value of power delivered by the user's supply (in this case 10 W).

By using the same equations presented above, it is possible to determine the on time TonN of each primary winding so as to make equal among them the electric power absorbed by the primary circuits at the input of the various converters. In this situation, for the three preceding cases, it is:

| Linea | Pg_{N} (W) | VN (V) | Ton_{N} (μs) | Pin_{N} (W) |
|---|---|---|---|---|
| 1 | 9.8375 | 55.2973 | 2.81802 | 9.7130 |
| 2 | 10 | 54.3928 | 2.8648 | 9.7130 |
| 3 | 10.4842 | 51.8812 | 3.0035 | 9.7130 |

In the latter case, the user connected to the longest phone line will deliver a greater electric power for compensating the greater losses along his phone lines.

It is now shown in detail the functioning of the supply unit as shown in the embodiment of FIG. 4. For the primary side, only one line will be taken into consideration because the scheme and the functioning is the same for all other lines.

The generic N-th line is, thus, connected throughout a protection circuit PROTECTION against over-voltages, and a low-pass input filter INPUT FILTER, the task of which is to insulate the related primary winding from the high frequency components of the signal eventually superposed to the DC supply (for example XDLS, G.Fast, etc.). The same filter functions also in the opposite direction, by filtering noise eventually generated by the converter itself toward the line; the considered filter has differential as well as common mode filtering properties.

The filter is connected to a diode bridge circuit for rectifying the applied voltage (the bridge makes the functioning of the circuit independent from the applied polarity). The smoothing capacitor fixes the primary DC voltage level VdcN available on a respective pair of intermediate nodes of the primary circuit.

This voltage VdcN, besides powering the primary side of the transformer [5N], supplies also the control circuit CB_N [3N] that accomplishes the following task. The circuit CB_N [3N], at the start-up, through the supply applied at the line N, drives the switch [7N] with driving pulses at a frequency close to the working frequency Fsw, so as at the secondary side [4] there is a voltage having a value such that the control block [1] starts functioning.

As soon as the control block [1] becomes active, the command pulses arrive through the opto-insulated gate [8N] to the control circuit CB_N [3N]. When these command pulses arrive, the control circuit enters in a functioning condition in which the command pulses are applied directly to the switch [7N] that, thus, from this instant onwards, will be directly controlled by the control block [1].

The issue of command pulses to the various switches [71], [72] . . . [7N] of each line will be determined by the presence of the supply voltage itself: this presence will be sensed by isolated measurement circuits [41], [42] . . . [4N], available on each line, that inform the control block [1] of the presence/absence of the same line providing also a measure thereof.

From the moment in which the control block [1] senses the voltage on a line, it switches the switch associated to the line and thus the relative primary circuit contributes to the transfer of power towards the output, in accordance to what is described above.

It is thus determined, as desired, the power sharing at the primary side.

The same control block [1] receives, through the current sensors [61], [62] . . . [6N], also information relative to currents flowing throughout the various windings, among which in particular the value of the peak current Ip at the various primary windings of the transformer.

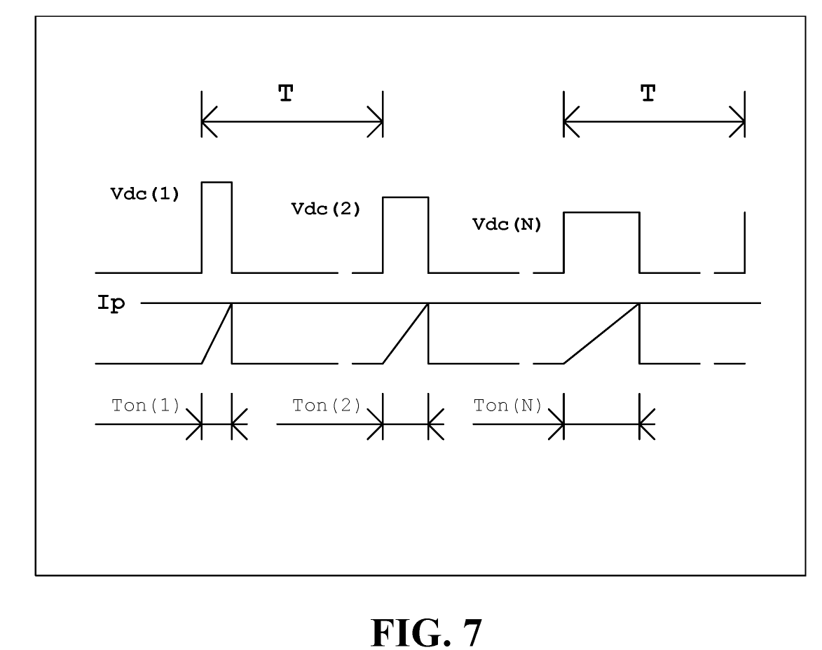

FIG. 8 shows the switching from the functioning of the system from 2 to 3 lines supplied at the same voltage with a consequent variation of the on time Ton necessary to the correct sharing of the power transferred to the load.

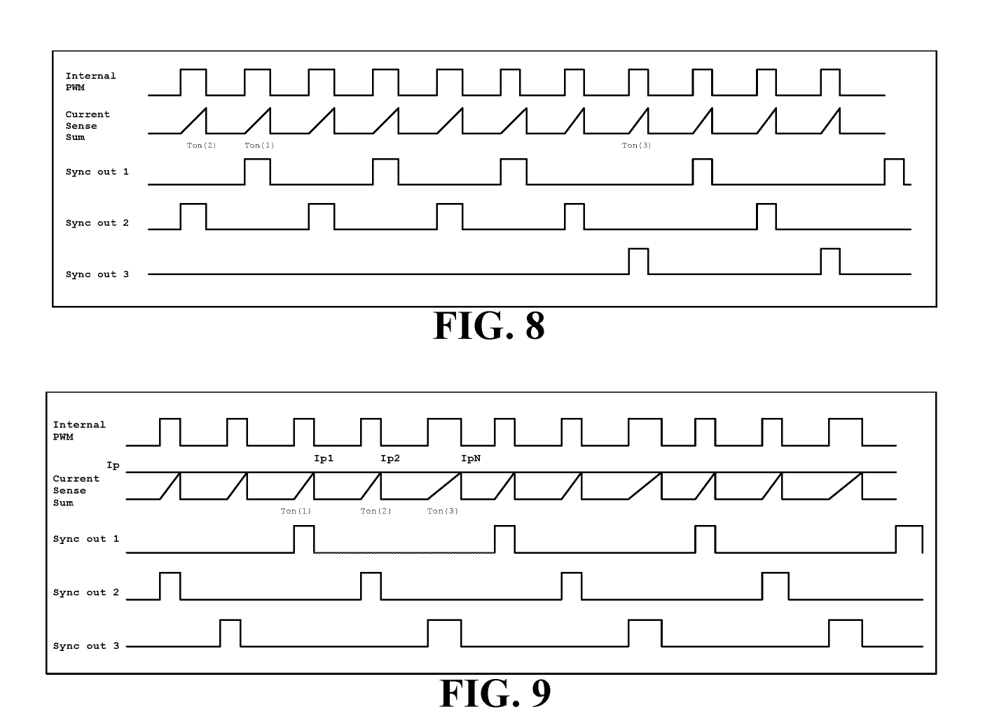

The control block [1] inserts in a synchronous mode the functioning of the switch number 3, inserting it within the functioning of the other 2 in a time multiplexing, so as not to alter the correct functioning of the transformer. Moreover, the working frequency of the transformer remains unchanged, whilst the switching frequency of the various switches is reduced according to an inverse proportion in respect to the active lines. FIG. 9 depicts the working situation relative to three supplies connected to the system with three different supply values.

Moreover, the control block [1] controls also the delivered supply voltage, in order to adjust it constantly to the load, drives in a synchronous mode the active rectifier [2] installed in correspondence of the output winding for increasing the global yield and monitors all anomalous situations of the load (overvoltages, overloads, short-circuits, etc.). It has also a control and debug port CONTROL PORT, necessary for transferring/receiving commands/controls/data provide by an intelligent external unit (microprocessor, PC, . . . ).

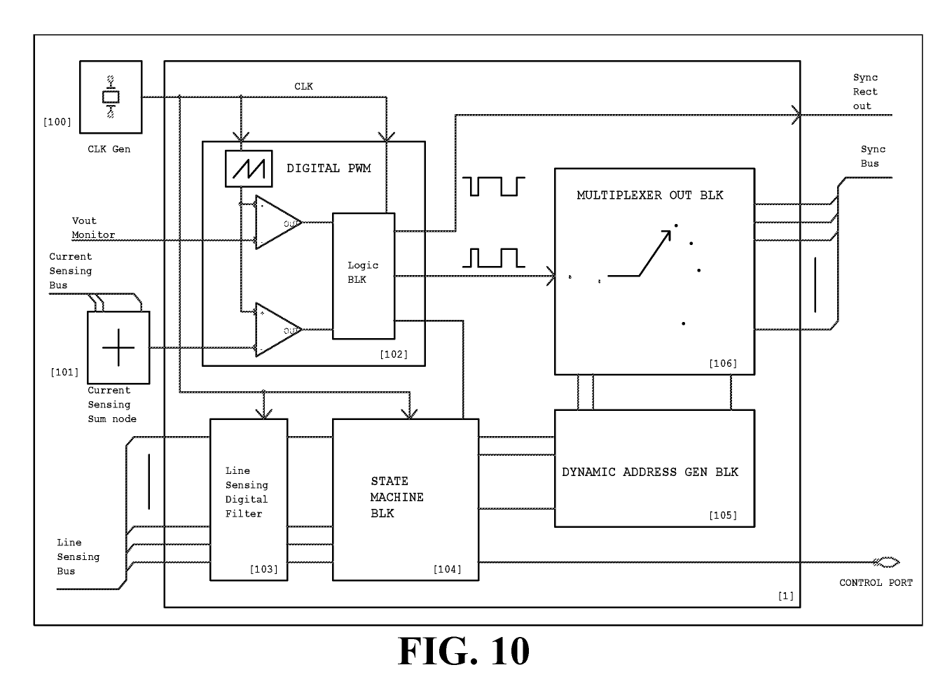

For the description of the functioning algorithm of the control block [1] reference is made to FIG. 10, that is a high level scheme of functional blocks present inside the device (for example of a CPLD or FPGA type) that physically implements it. The functional blocks depicted in FIG. 10 represent digital functions that realize physically the algorithm implemented inside the block [1].

The blocks CLK_gen [100] and Current Sensing Sum Node [101] are outside the block CB [1], and represent respectively the generator of external clock and the summation node of the currents coming from the current sensors [61], [62], . . . [6N].

The control block [1] is substantially a synchronous machine the external clock of which drives all internal functional blocks.

The internal functional blocks are:
Digital PWM [102]
Line Sensing Digital Filter [103]
State Machine [104]
Dynamic Address Gen [105]
Multiplexer Out [106]

The above block realize the following functions:

### Digital PWM [102]

The block Digital PWM represented with a ramp generator and two comparators accomplishes the task of generating command pulses (at the output of the logic block in cascade thereto) the time width of which depends upon the value of the instantaneous current peak (as explained above) and upon the power level requested at the output (from the measure of the unfiltered output voltage Vout Monitor).

It generates further a complementary signal (inverted) Sync Rect Out in respect to that of command pulses Sync, for driving the switch [2] synchronous to the secondary side.

### Line Sensing Digital Filter [103]

The digital filter of the voltages sensed at the hold capacitors Line Sensing Digital Filter, carries out a low-pass digital filtering of the signals corresponding to these voltages in order to remove eventual spurious variation of state thereof, due to spurious contacts when a power connection is established by users or because of disturbances over the connection lines that could be wrongly interpreted by the state machine.

### State Machine [104]

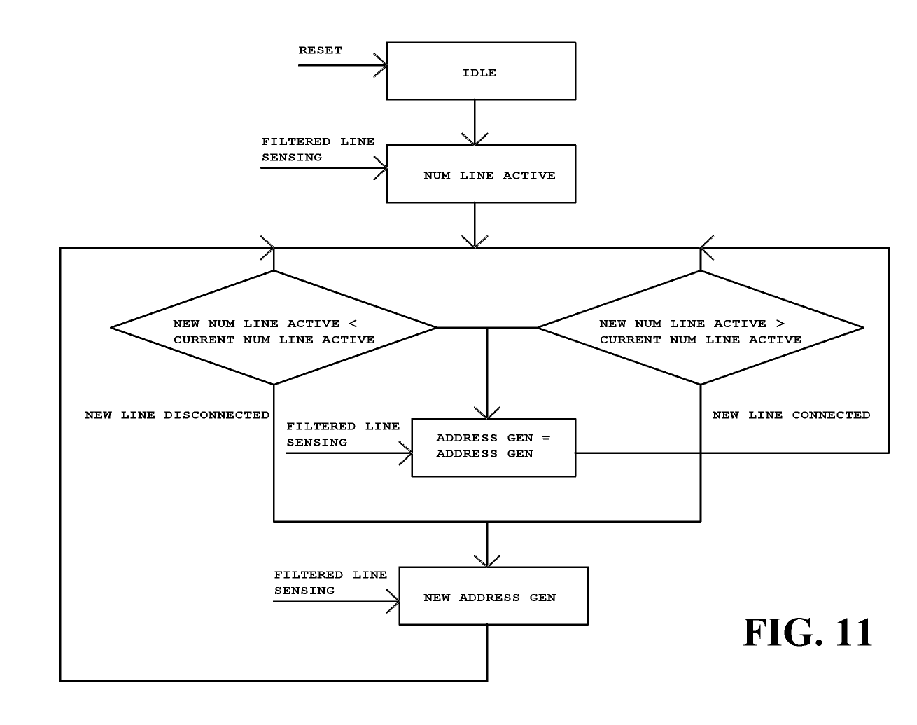

The state machine [104] is the decision block of the device in which the flow chart depicted in FIG. 11 is implemented.

This block exchange information with an eventually present external intelligent unit through the port CONTROL PORT.

### Dynamic Address Gen [105]

This functional unit generates dynamically the addresses necessary to the functioning of the synchronous multiplexer in cascade.

The generated addresses depend upon the commands coming from the state machine to which it is connected.

### Multiplexer Out [106]

The output stage Multiplexer distributes dynamically the pulses coming from the block PWM [102] towards the outputs Sync bus, according to the addressing coming from the address generator to which it is connected.

In order to understand the functioning algorithm of the state machine [104], reference is made to the flow chart of FIG. 11. The state machine passes always through the same states once resumed from the RESET state.

From the IDLE state successive to the RESET state, the state machine is always updated (FILTERED LINE SENSING) on the number of the lines connected to the appliance from the counter of the active lines (NUM LINE ACTIVE).

In the flow chart there are two decisional nodes of comparison of the updated number of sensed active lines (NEW NUM LINE ACTIVE) with the number of active lines sensed at the previous cycle (CURRENT NUM LINE ACTIVE). In the case in which the two numbers are equal to each other, it means that there is no variation of the number of active lines (stable condition), thus there is no need of varying the address (ADDRESS GEN=ADDRESS GEN) of the synchronism pulses towards the external outputs. The appliance continues functioning regularly keeping the same synchronism pulses towards the external outputs that had previously identified.

In the case in which there is a variation, that is an increment (NEW LINE CONNECTED) or a reduction (NEW LINE DISCONNECTED) of the number of active lines, there is the need of adjusting the address of the active lines (NEW ADDRESS GEN) depending upon the updated scheme of sensed active lines (line sensing). Once updated the address, the state machine returns to the previous control state waiting for new adjustments.

Preferably, this flow chart is run by the state machine at about 100 times the output frequency of the external synchronism pulses, in order to be ready to vary the address before generating the synchronism pulses, as shown in FIG. 8.

The functions of the present invention may be summarized in the following synoptic table, in order to make them more evident and comparable to the present state of the art:

| | | | SW | | | | |
|---|---|---|---|---|---|---|---|
| | | | frequency | Noise | | | |
| | Electrical | | at each | reinjected | | | |
| Type | insulation | Efficiency | DC/DC | at input | Size | Miniaturization | Uses |
| Secondary | Among pairs | Good | Fsw | High | Large: N | Poor | xDSL, |
| Power sharing | and between the | | | (Fsw + | transformers | | G-FAST |
| (prior art) | pairs and the | | | harmonics | | | |
| | secondary | | | of Fsw) | | | |
| Primary | Among the pairs | High | Fsw/N | Low | Small: one | High | xDSL, |
| Power sharing | and between the | | | (Fsw/N + | transformer | | G-FAST |
| (invention) | pairs and the | | | harmonics | | | |
| | secondary | | | of Fsw/N) | | | |

The present invention provides in general a remote supply system of a remote appliance (of industrial typo, telecommunications, etc.). It is useful, in particular, in all those applications that involve a remote appliance of any type (analog or digital) supplied in a remote fashion and that need of a supply system in which the overall power absorbed thereby is equal to the sum of the single contributions of the supply sources involved in the power delivering.

In particular the invention satisfies the requirements of very large integration (in general required on the remote terminal), of electrical insulation among the sources connected to this system, of low costs for realizing the system and of high power conversion efficiency and of very low power dissipation, that are very stringent in present application. These features make it particularly adapted for all those application for transmitting a supply towards remotely supplied terminals in a Reverse Powering mode: terminals for optical distribution multi-ports supplied in a FTTdP mode, opto-electrical mini-Dslam, etc.).

1. A method for generating a supply voltage for a digital communication appliance using a powering unit of reverse power feed type comprising a primary block and a secondary block magnetically coupled to the primary block, the primary block comprising a plurality of identical primary circuits electrically isolated one from the other, each primary circuit comprising:
an input circuit having a pair of input terminals adapted to be connected with a respective phone line, said input circuit being configured to generate in operation a respective primary DC voltage on a respective pair of intermediate nodes,
a primary winding functionally connected with said pair of intermediate nodes through a respective switch electrically connected in series,
a voltage sensor configured to sense said primary DC voltage,
a driving circuit controlled through a respective command signal and functionally connected to the respective pair of intermediate nodes for being powered with said primary DC voltage, configured for switching cyclically the respective primary winding by closing/opening the respective switch,
said secondary block comprising:
at least a secondary winding magnetically coupled with the primary windings of the primary block and functionally connected with output terminals of the powering unit for generating said supply voltage,
a control block connected to said voltage sensors, configured for being powered through said at least one secondary winding and for generating said command signal of each driving circuit;
said method comprising the steps of:
sensing said primary DC voltage of each primary circuit;
generating, at each switching cycle, only one of said command signals only for a driving circuit chosen at each cycle among the driving circuits of the primary circuits the primary DC voltage of which is substantially nonnull;
commanding the closing/opening of only one respective switch during each switching cycle keeping opened all other switches of the primary block.

2. The method according to claim 1, comprising the steps of:
sensing a primary current flowing throughout each respective primary winding;
generating said command signals through said control block for opening respective switches when the respective primary currents attain respective current thresholds.

3. The method according to claim 2, comprising the step of determining said current threshold in function of the respective sensed primary DC voltage so as each primary circuit absorbs at its input from the respective active phone line a same fraction of the electric power that the powering unit delivers throughout the output terminals.

4. The method according to claim 2, comprising the step of determining said current thresholds so as the electric power delivered on each active phone line upstream the powering unit is substantially equal to a same fraction of the electric power that the powering unit delivers throughout the output terminals.

5. The method according to claim 2, comprising the step of determining said current thresholds at each switching cycle in function of the number of active phone lines and of energy to be delivered to said digital communication appliance during the switching cycle.

6. A powering unit of reverse power feed type adapted to generate a supply voltage for a digital communication appliance, comprising a primary block and a secondary block magnetically coupled to the primary block, the primary block comprising a plurality of identical primary circuits electrically isolated one from the other, each primary circuit comprising:
an input circuit having a pair of input terminals adapted to be connected with a respective phone line, said input circuit being configured to generate in operation a respective primary DC voltage on a respective pair of intermediate nodes,
a primary winding functionally connected with said pair of intermediate nodes through a respective switch electrically connected in series,
a voltage sensor configured to sense said primary DC voltage,
a driving circuit controlled through a respective command signal and functionally connected to the respective pair of intermediate nodes for being powered with said primary DC voltage, configured for switching cyclically the respective primary winding by closing/opening the respective switch,
said secondary block comprising:
at least a secondary winding magnetically coupled with the primary windings of the primary block and functionally connected with output terminals of the powering unit for generating said supply voltage,
a control block connected to said voltage sensors, configured for being powered through said at least one secondary winding and for generating said command signal of each driving circuit;
wherein
said control block is functionally connected to all voltage sensors of the primary circuits and is configured for generating at each switching cycle only one of said command signals only for a driving circuit chosen at each cycle among the driving circuits of the primary circuits the primary DC voltage of which is substantially nonnull, for commanding the closing/opening of only one respective switch during each switching cycle while keeping opened all other switches of the primary block.

7. The powering unit according to claim 6, wherein said secondary block comprises a single secondary winding magnetically coupled on a same magnetic core with all said primary windings of the primary block at the same time.

8. The powering unit according to claim 6, wherein:
each of said primary circuits comprises a current sensor, configured for generating a first sense signal representative of a primary current flowing throughout the respective primary winding, said first sense signal being non null when a nonnull current flows throughout the respective primary winding;
said control block is connected to said current sensors and is configured to generate said command signals for opening respective switches when the respective primary currents attain respective current thresholds.

9. The powering unit according to claim 8, wherein said current thresholds are determined in function of the respective sensed primary DC voltage so as each primary circuit absorbs in input from the respective active phone line a same fraction of the electric power that the powering unit delivers throughout the output terminals.

10. The powering unit according to claim 8, wherein said current threshold values are determined so as the electric power delivered on each active phone line upstream the powering unit is substantially equal to a same fraction of the electric power that the powering unit delivers throughout the output terminals.

11. The powering unit according to claim 8, wherein said control block is a programmable logic circuit or a microprocessor or a state machine and has a programming input terminal for receiving signals representative of said current thresholds for each primary circuit.

12. The powering unit according to claim 6, wherein:
said voltage sensors are optically isolated operational amplifiers;
each primary circuit comprises:
a low-pass filter functionally connected to the respective pair of input terminals, configured for generating a low-pass replica voltage of the voltage available on the respective phone line,
a rectifying circuit configured to receive said low-pass replica voltage and to generate the respective rectified voltage on the respective pair of intermediate nodes,
an optically isolated gate configured to generate said active command signal;
said secondary block comprises:
a secondary low-pass filtering circuit, configured to generate said supply voltage as a low-pass replica voltage of a secondary rectified voltage induced on said at least one secondary winding.
